(19) United States
(12) Patent Application Publication
(10) Pub. No.: US 2016/0355299 A1
(43) Pub. Date: Dec. 8, 2016

(54) CARRYING CASE FOR ELECTRONIC GAME COMPONENTS

(71) Applicant: Robert A. Lapoint, Maple Grove, MN (US)

(72) Inventor: Robert A. Lapoint, Maple Grove, MN (US)

(21) Appl. No.: 15/165,656

(22) Filed: May 26, 2016

Related U.S. Application Data
(60) Provisional application No. 62/169,864, filed on Jun. 2, 2015.

(51) Int. Cl. B65D 25/04; E05D 7/00; B65D 81/02

(52) U.S. Cl. CPC B65D 25/04; B65D 81/02; E05D 7/009

(57) ABSTRACT

A carrying case for electronic game components includes a briefcase-like container having a pair of mating case halves joined together along a bottom edge of each by a piano hinge. Hinged stop bars are pivotally joined between opposed sides of the case halves to restrict rotation of one of the case halves with respect to the other to 90°. A first case half is designed to hold a video display screen while the second case half contains a console, one or more game controllers, a DC power converter and plural CD's in separate pockets formed in a foamed plastic sheet. The case includes a terminal strip whereby electrical power and control signals from game controllers interface with the display screen and the game consol.

### CROSS-REFERENCED TO RELATED APPLICATIONS

The present application claims priority to provisional application, Ser. No. 62/169,864, filed Jun. 2, 2015, and which is hereby incorporated herein by reference.

### STATEMENT REGARDING FEDERALLY SPONSORED RESEARCH OR DEVELOPMENT

Not applicable

I. Field of the Invention:

This invention relates generally to a briefcase-like piece of luggage and, more particularly, to a carrying case especially adapted for containing the components of electronic games such as an Xbox One, from the Microsoft Corporation, a Play Station 4 from the Sony Corporation or a Wii from the Nintendo Corporation.

II. Description of the Prior Art:

Electronic games with video displays have proven to be a highly popular mode of entertainment for children, teens and many adults. Microsoft introduced the Xbox One on Nov. 22, 2013 and in less than two months, has sold three million units. It was a follow-on to a product called the Xbox 360 and between the date of its introduction in 2005 and in April 2013 had sold 77.2 million games. Sony's Play Station system has exhibited similar commercial success. Released in 2006, Sony has sold over 80 million consoles worldwide as of November 2013.

Typically, these electronic games will include an LCD or a LED display screen, a control console, at least one and usually two hand-held controllers, a set of audio headphones and an AC to DC battery charger. The console component in these games will typically contain a CD disc player on which DVDs containing game software is stored.

When it is recognized that game players may wish to transport these video game components from one place to another and that certain of the components, such as the video display unit are somewhat fragile, a need exists for a carrying case that can conveniently contain and protect the aforementioned components from damage during transport. It is the purpose of the present invention to provide such a carrying case.

### SUMMARY OF THE INVENTION

The present invention comprises a carrying case for storing and transporting electronic video game components. It is constructed like a solid-wall type briefcase having a pair of generally rectangular case halves that are hinged together along a bottom edge and having a carrying handle on a wall surface opposite from the hinged edges. At least one, and preferably two foldable stop members are pivotally coupled to the side walls of the pair of case halves that only allow the case halves to rotate 90° about the hinge that joins them together.

Located in the case half that extends vertically when the case halves are fully opened are padded clamps that are adapted to secure a video display screen in place within its case half. The case half that extends horizontally when the case halves are fully opened contain an open cell foam layer having plural recesses therein that are sized to snuggly hold the game console in one recess, a set of player controllers in another, headphones in still another and a console battery charger in yet another. The foam tends to shock mount the components when the case halves are closed when the game is not in use, but is being carried from one place to another.

### DESCRIPTION OF THE DRAWINGS

The foregoing features, objects and advantages of the invention will become apparent to those skilled in the art from the following detailed description of a preferred embodiment, especially when considered in conjunction with the accompanying drawings in which:

FIG. 1 is a perspective view of the electronic game carrying case of the present invention when the case is closed;

FIG. 2 is a right side elevation view of the electronic game carrying case when the case is closed;

FIG. 3 is a right side elevation view of the electronic game carrying case when the case is open;

FIG. 4 is a top view of the electronic game carrying case of the present invention when the case is open; and

FIG. 5 is a front elevation view of the electronic game carrying case with the case half 14 broken away to reveal the interior of the case half 12.

### DESCRIPTION OF THE PREFERRED EMBODIMENT

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise.

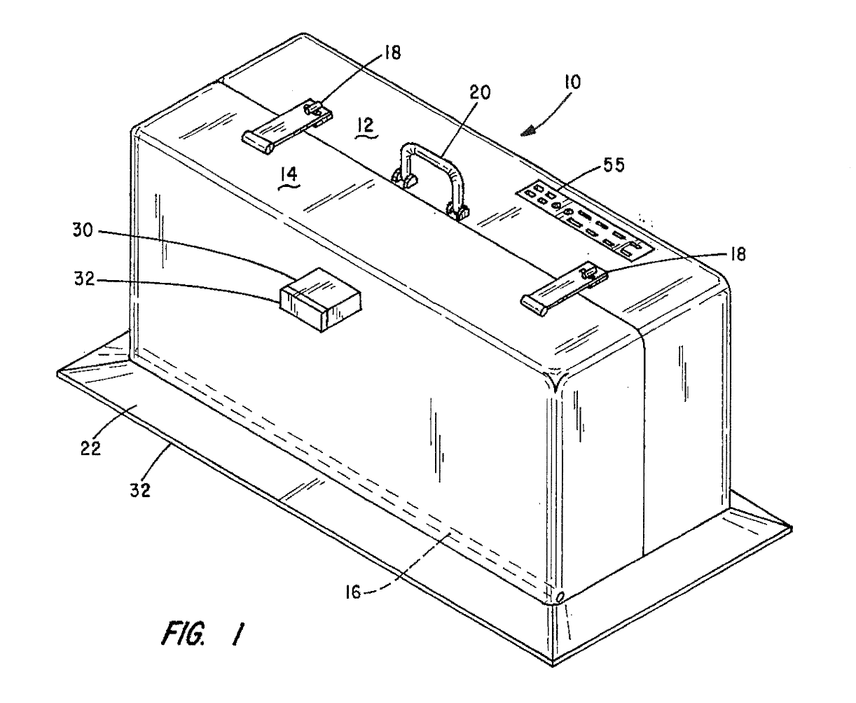

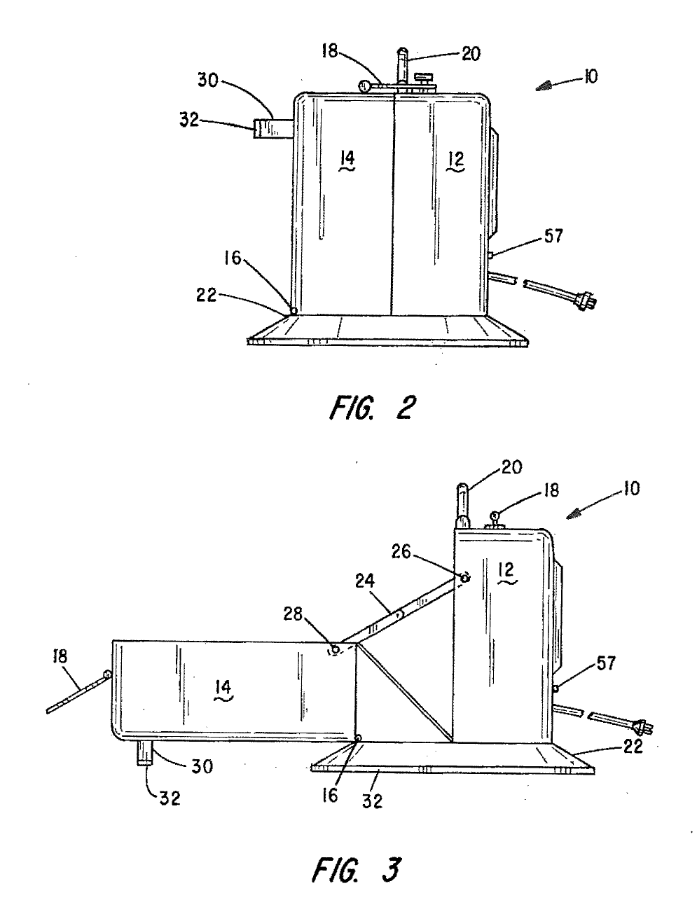

Referring to FIG. 1, the present invention is seen to comprise a carrying case indicated generally by numeral 10 having first and second, generally rectangular case halves 12 and 14 having a living hinge when molded from plastic or a piano-type hinge 16 when fabricated from leather. The hinge extends the length dimension of the case 10 allowing the case halve 14 to be rotated from a closed position, as illustrated in FIG. 1, to an open position best seen in FIG. 3. The case 10 includes latches 18 of a conventional type for securing the carrying case in its closed condition. A handle 20 is provided to aid in carrying the case and its contents.

As further seen in FIG. 1, the case 10 is preferably affixed to a base member 22 that extends laterally outward beyond the front, rear and side surfaces of the case 10 to add greater stability when the case is both open and closed, as shown in FIGS. 1 and 3.

As further seen in FIG. 3, a foldable stop member 24 is pivotally joined to the first case half 12 at pivot 26 and to the second case half 14 at pivot 28. When the case 10 is in its open condition, the stop member 24 provides support to the vertically oriented case half 12. A foot member 30 is provided whose height dimension is that of the base 22 such that when the base 22 is placed on a level surface, the foot 30 helps to hold the second case half 14 in a horizontal disposition. Both the base 22 and the foot member 30 preferably have a non-slip rubber pad as at 32 affixed to it so as to rest on a support surface, such as a desk top.

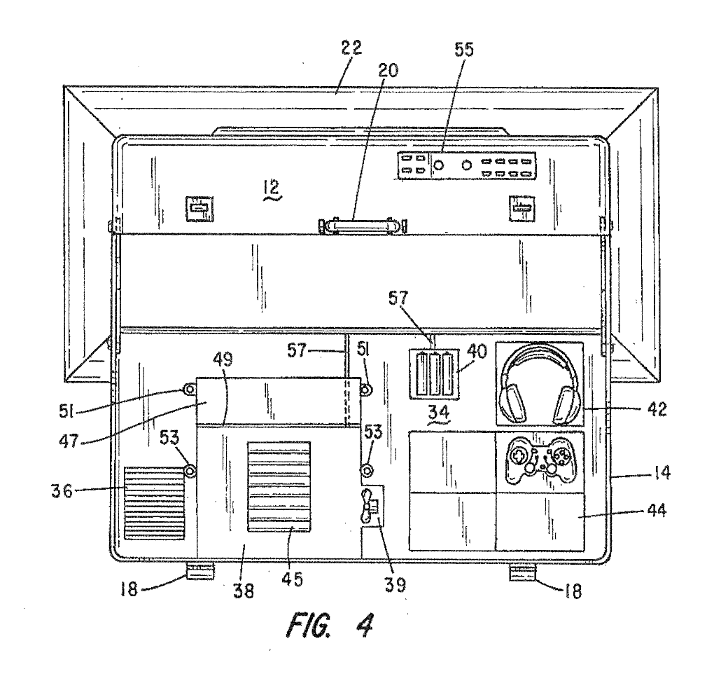

Turning next to FIG. 4 which shows a top view of the game carrying case when the case half 14 is open relative to the case half 12. Contained within the now horizontal case half 14 is a thick pad of an open-cell foam material 34 having a plurality of recesses 36, 38, 40, 42 and 44. The recess 36 is dimensioned to releasably hold a plurality of game discs (CDs) that contain the software for playing a selected game. The cavity 38 is designed to hold the game console having a disc drive for playing a selected one of the discs retrieved from the storage recess 36. Communicating with the cavity 38 is a laterally extending recess 39 that is provided for holding an air circulating fan. A vent opening 45 is provided through the case half and sponge liner to allow escape of heat generated by the console during game play.

A hinged flap retainer or door 47 is provided to prevent the controller from shifting during transport. By folding the flap about a living hinge 49, the snaps 51 are mated with buttons 53 to at least partially overlay the controller contained in recess 38.

The recess 40 is provided to hold a battery charger in that the game console may typically be operated from a portable rechargable battery supply.

The recess 42 is dimensioned to contain and releasably hold at least one and preferably two sets of headphones whereby the game players may listen to audio information commonly recorded on the game disc, along with the software for operating the game.

The recess 44 in the foam pad 34 is designed to contain at least two and perhaps up to four game controllers which are hand-held devices containing a number of pushbuttons and switches which, when activated, impact a movement and operation of graphic objects displayed on a video screen.

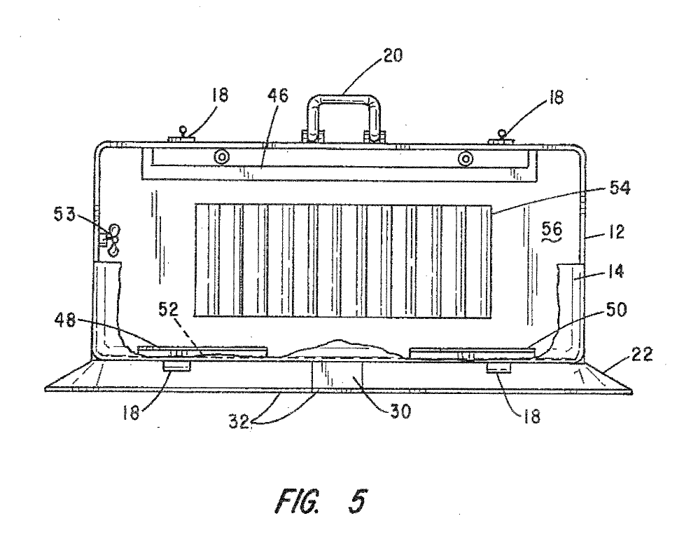

Referring to FIG. 5, it shows a front elevation view of the game carrying case with the case in its open condition. The case half 12 is designed to hold a video LCD or LED display screen allowing players to view the progress of the game being played. To secure the video display screen in place within the case half 12, a moveable fastener 46, which may be of the Velcro® type, is provided and is lined with a foam pad to engage an upper surface of a frame that surrounds the video display screen. The bottom edge of the display screen frame is supported on pads 48 and 50 affixed to the inner bottom side wall 52 of the case half 12. To allow heat dissipation from the video display screen, a fan 53 mounted to the case half 12 and a vent 54 is formed through the rear wall 56 of the case half

Built into the top of the case half 12 is an electrical connector strip 55 whereby power cords and HDMI cables (not shown) can be used to supply power to a console in recess 38, the display and to a battery charger in recess 40. Video signals from the game controller to the video display held in the case half 12 are coupled through connector 55, as previously described. A coaxial cable jack 51 is mounted on the back of case half 12 and internal wiring (not shown) leads to the game console. Slots, as at 57 in FIG. 4, formed in the sponge layer are used to route the power cords and cables to the appropriate components.

From what has been disclosed herein, those skilled in the art will appreciate that the carrying case of the present invention is adapted to hold the components of video game players, allowing these components to be carried from place to place without damage by shock and vibration to the components that may occur during transport.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

1. A carrying case for electronic game components comprising:
a) a first case half member having a generally rectangular planar front surface with four pivotal, perpendicular side surfaces of a predetermined height dimension joined to the front surface along side edges of the rectangular and planar front surface;
b) a second case half member having a generally rectangular and planar rear surface with four mutually perpendicular side surfaces of a predetermined height dimension joined to the rear surface;
c) a piano hinge connecting one of the four side surfaces of the first case half member to a corresponding one of the four sides of the second case half member and allowing the first case half member to open up to 90° with respect to the second case half member;
d) an insert defining a plurality of pockets fitted into the first case half member, said pockets adapted to hold at least a game console, a plurality of compact disks and at least one game console; and
e) said second case half member adapted to hold a video display panel.

2. The carrying case of claim 1 and further including means for latching said first and second case half members together when the front surface and the rear surface are in parallel, spaced-apart relation.

3. The carrying case of claim 1 and further including a carrying handle affixed to another of the four side surfaces of either the first or second case half members, said another of the four side surfaces being in parallel spaced relation to the piano hinge.

4. The carrying case of claim 1 and further including a base abutting said one of the four sides of the first case half member and the corresponding one of the four sides of the second case half member, said base extending a predetermined distance beyond the front surface, the rear surface and opposed side surfaces of the carrying case when the first and second case half members are latched together.

5. The carrying case of claim 1 and further including an electrical connector strip set in one of the side surfaces of either the first or the second case half members whereby electrical power and control signals may be applied to electronic game components when disposed within the carrying case.

6. The carrying case of claim 1 and further including means for circulating ambient air over the game console and the video display panel when the game console and video display panel are contained in the carrying case.

7. The carrying case of claim 6 wherein the means for circulating includes vent openings formed through at least one of the front surfaces and the rear surface.

8. The carrying case of claim 1 and further including a motor driven fan contained within the carrying case proximate the vent openings.

9. The carrying case of claim 1 and further including foldable stop members pivotally joined to the first and second case half members, said stop members providing support to the second case half member when opened 90° with respect to the first case half member.

10. The carrying case of claim 1 wherein the insert comprises a foamed plastic material.

11. The carrying case of claim 1 and further including means adapted to releasably a video display panel in the second case half member.

12. The carrying case of claim 5 and further including a coaxial cable jack extending through a back surface of the second case half.
